(19) United States
(12) Patent Application Publication
(10) Pub. No.: US 2024/0340320 A1
(43) Pub. Date: Oct. 10, 2024

(54) SYSTEM, APPARATUS AND METHOD FOR DATA MANAGEMENT

(71) Applicant: HUAWEI TECHNOLOGIES CO., LTD., SHENZHEN (CN)

(72) Inventors: Bidi YING, Kanata (CA); Xu LI, Kanata (CA); Hang ZHANG, Kanata (CA)

(73) Assignee: HUAWEI TECHNOLOGIES CO., LTD., SHENZHEN (CN)

(21) Appl. No.: 18/747,816

(22) Filed: Jun. 19, 2024

Related U.S. Application Data
(63) Continuation of application No. PCT/CN2021/141040, filed on Dec. 24, 2021.

(51) Int. Cl. H04L 9/40

(52) U.S. Cl. CPC H04L 63/20; H04L 63/101

(57) ABSTRACT

A method includes an access policy management unit receiving from an access policy entry point (APEP), a request for data management. In response to the request the access policy management unit sends a response to acknowledge a generation of an access control policy for management of the data to the APEP. A data description includes an indication of an owner of the data expects to know a usage of the data. The access control policy is based on a security requirement related to the data, a privacy requirement related to the data, data information or a data operation permission related to the data, when the owner of the data expects to know the usage of the data. When the owner of the data does not expect to know the usage of the data, the policy is based on data information and a data operation permission related to the data.

### CROSS-REFERENCE TO RELATED APPLICATIONS

This application is a continuation of International Patent Application No. PCT/CN2021/141040, filed on Dec. 24, 2021, the disclosure of which is hereby incorporated by reference in its entirety.

### TECHNICAL FIELD

The present invention pertains to the field of data management, and in particular to methods, apparatuses and systems for access control of data to protect data privacy.

### BACKGROUND

The handling and storage or user data will be a key enabler to achieve the full potential of future networks and services. Proper implementation of data collection, data storage, data sharing, data auditing, and other uses of data face significant technical challenges. Specifically, multiple data stakeholders from different industrial sectors, such as mobile operators, technology vendors, data centers, and application providers, need to collaboratively manage the lifecycle of personal user data or network operation data.

Data privacy regulations are taking effect and significantly reshaping the privacy landscapes of the future network. In particular, the European General Data Protection Regulation (GDPR) defines legal requirements on the personal user data from three aspects: 1) it grants users a wide range of legal rights to obtain information and control operations on their personal data; 2) it requires “restricted processing” of personal data, where a set of privacy-preserving techniques can be adopted to enhance user identity privacy and data confidentiality; and 3) it requires privacy compliance over the data lifecycle events that enforces obligations of data stakeholders. Any data stakeholder failing to comply with the GDPR requirements may face severe financial and legal consequences. Without proper solutions for privacy preservation under the GDPR, there will be significant data barriers for data stakeholders in the future network.

Often, data is centrally controlled by a third party (e.g., unified data management (UDM) deployed by a mobile operator, or cloud storage deployed by a third party). This centralized architecture is not suitable for the complicated networks of the future. From the perspective of security and privacy, a centralized solution can suffer from various attacks, such as having a single point of failure and remote hijacking attacks, which cause unexpected data leakage. Furthermore, multiple data stakeholders from different industrial sectors may not trust a third party and be unwilling to provide sensitive data to the third party. Some researchers have proposed providing “smart contracts” that can be deployed and checked by multiple data stakeholders while connected to a blockchain. The contracts transform access rules to programmatic code that can be automatically executed on a blockchain. However, this conversion has limitations, as access rules that encode legislation is often subject to interpretation and can lead to leakage of user's private information. Some researchers may ask a trusted third party (e.g., an auditor) for data operation surveillance or auditing. Also, data owners may be unwilling to provide sensitive access rules to a third party. Those issues should be considered in the design and implementation of future networks.

Current techniques (e.g., K-anonymity, mix-zone, encryption methods such as proxy re-encryption or multi-party communications (MPC)) may be used for privacy protection and anonymization. However, different techniques may have different levels of performance. Since multiple stakeholders may have different security or privacy requirements, how to dynamically select one to protect an access control policy and how to implement the solution to protect access control policy may be a challenging issue for data management.

Therefore, there exists a need to protect data privacy, e.g., in an environment including multiple untrusted parties.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide methods, apparatuses and systems that provide data management by generating an access control policy to enable management on data accordingly to realize protection of data privacy. According to embodiments, a policy in anonymization can be published or provided to an untrusted party without a leak of data privacy.

In accordance with embodiments of the present invention, there is provided a method including receiving, by an access policy management unit from an access policy entry point (APEP), a request for data management. The request for data management includes a data description of data. Then, in response to the request for data management, sending, by the access policy management unit to the APEP, a response to acknowledge a generation of an access control policy for management of the data. The generation of the access control policy is based on the data description of the data. The data description of the data includes an indication indicating whether an owner of the data expects to know usage of the data. The generation of the access control policy includes; when the indication indicates that the owner of the data expects to know the usage of the data, a generation of the access control policy based on one or more of a security requirement related to the data, a privacy requirement related to the data, data information and a data operation permission related to the data. When the indication indicates the owner of the data does not expect to know the usage of the data, a generation of the access control policy based on data information and a data operation permission related to the data.

This may provide a technical benefit of enabling a data owner of data to control its own data to meet privacy regulations (e.g. GRPR) by providing a generation of data access control policies based on an indication from the data owner of the data.

In embodiments, the method further includes sending, by the access policy management unit to an AP decision unit, a first message. The first message includes a policy ID of the access control policy, an index indicating an anonymization solution, and one or more parameters related to the anonymization solution. The method also includes sending, by the access policy management unit to a blockchain unit, a second message. The second message includes a processed access control policy wherein the processed access control policy is a result of processing the access control policy according to the anonymization solution and the one or more parameters related to the anonymization solution, the policy ID of the access control policy, the index indicating the anonymization solution, and the one or more parameters related to the anonymization solution.

This may provide a technical benefit of supporting a number of anonymization solutions determined for processing an access control policy for data privacy protection in different scenarios, e.g. data behaviour audit, data access based on policy, and etc.

In embodiments, prior to sending the first message and the second message, the method further includes determining, by the access policy management unit, an anonymization solution for a privacy protection of the access control policy according to one or more of a strength of the privacy protection, complexity of a resource for a network computation, tolerance of a time delay due to the generation of the access control policy, or complexity of a resource for a network communication.

This may provide a technical benefit of supporting dynamic selection of an anonymization solution based on characteristics of the available anonymization solutions. General performance of the system in aspects of transmission delay, data privacy protection, and complexity of resource usage can be improved due to the dynamic selection of the anonymization solution.

In embodiment, prior to sending the response, the method further includes selecting from a set of types of the access control policy, by the access policy management unit, a type of the access control policy according to the data information and the data operation permission.

This may provide a technical benefit of supporting a selection of an access control policy based on input, such as data information and data operation permission, from the data owner so that the data owner can influence the selection by providing customized information.

In embodiments, the method further includes receiving, by the blockchain unit from the access policy management unit, the second message and storing, by the blockchain unit, information received from the access policy management unit.

This may provide a technical benefit of utilizing blockchain technology for the storage of access policy management unit information therein.

In embodiments, the method further includes receiving, by the AP decision unit from the access policy management unit, the policy ID of the access control policy. The index indicates the anonymization solution and the one or more parameters related to the anonymization solution. Also, receiving, by the AP decision unit from a data management controller, a request for accessing the data. Obtaining, by the AP decision unit from the blockchain unit, the processed access control policy for the data. As well, sending, by the AP decision unit to the data management controller, a response indicating whether the data is accessible.

This may provide a technical benefit of simplifying the implementation by utilizing a policy ID to manage and access anonymization solutions and their associated parameters. Furthermore, blockchain technology may be used to improve access to the access control policy and data.

In embodiment, the method further includes determining, by the AP decision unit, whether the data is accessible based on the data policy.

In further embodiments, the obtaining the processed access control policy for the data includes sending, by the AP decision unit to the blockchain unit, a policy access request for an access control policy for the data. The policy access request from the AP decision unit includes one or more of data information indicating data to be accessed, and policy information including a policy ID. Also, receiving, by the AP decision unit, from the blockchain unit, a policy access response including the processed access control policy and a policy ID of the access control policy.

In embodiments, the method further includes de-processing, by the AP decision unit, the processed access control policy received from the blockchain based on the anonymization solution and the one or more parameters related to the anonymization solution.

In embodiments, after the de-processing the processed access control policy, the method further includes sending, by the AP decision unit to a location server, a location query for a location of a data consumer of the data, and receiving, by the AP decision unit from the location server, the location of the data consumer of the data. The AP decision unit determines whether the data is accessible based on the data policy and the location of the data consumer of the data. In embodiments, the method further includes determining, by the AP decision unit, to send the location query according to one or more of the privacy requirement included in the data description of the data, wherein the privacy requirement indicates a location check is needed, and a local regulation of privacy protection.

This may provide a technical benefit of enabling the use of location restrictions as specified by local regulations when accessing data so that requirements on privacy regulations (e.g. GDPR) can be met.

In embodiments, the processing the access control policy includes an encryption of the access control policy and the de-processing the processed access control policy includes a decryption of the processed access control policy.

This may provide a technical benefit of utilizing encryption and decryption technology to improve the security of embodiments.

In embodiments, the one or more parameters related to the anonymization solution includes a value of k when the anonymization solution is a K-anonymity solution, one or more parameters for polynomial functions when the anonymization solution is a multiple player computation (MPC) solution, and a re-encryption key generation function and public keys when the anonymization solution is a proxy re-encryption solution.

In embodiments, the data description of the data includes one or more of the security requirement and the privacy requirement, the data information, and the data operation permission.

In embodiments the response includes an identifier of the access control policy.

In accordance with embodiments of the present invention, there is provided an apparatus including a processor coupled with a memory storing instructions, which when executed by the apparatus, cause the apparatus to perform the method of any one of the methods described herein.

In accordance with embodiments of the present invention, there is provided a computer readable medium including instructions, which when executed by a processor, cause an apparatus to perform the methods described herein.

In accordance with embodiments of the present invention, there is provided a system including an access policy management unit and an access policy entry point (APEP), which are respectively configured to implement steps in the methods described herein.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates an architecture for implementing a data management solution, according to an embodiment.

FIG. 2 illustrates an architecture for implementing access controls in a network, according to an embodiment.

FIG. 3 illustrates a table of access control policy types and their characteristics, according to an embodiment.

FIG. 4 illustrates a table of anonymization solutions and their characteristics, according to an embodiment.

FIG. 5 illustrates a table comparing access control policies and anonymization solutions, according to an embodiment.

FIG. 6 illustrates a signal flow diagram for dynamic configuration of anonymization solutions and access policies, according to an embodiment.

FIG. 7 illustrates a signal flow diagram for a policy access control procedure, according to an embodiment.

FIG. 8 illustrates an electronic device that may perform any or all of operations of the methods and features described herein, according to an embodiment.

It will be noted that throughout the appended drawings, like features are identified by like reference numerals.

### DETAILED DESCRIPTION

Embodiments of the present disclosure relate to methods and systems that incorporate an architecture that includes an access control module to provide policy management and data protection. Embodiments preserve data operation transparency when handling privacy issues caused by publishing or providing access to rules, to a third party. Policies implementing data anonymization may be dynamically configured. Furthermore, the architecture could provide access control policies compliant with requirements of data protection regulations, such as GDPR.

Embodiments of the present disclosure include methods and systems to manage data resources, selecting and managing access policies, dynamically configure anonymization solutions, and accessing data.

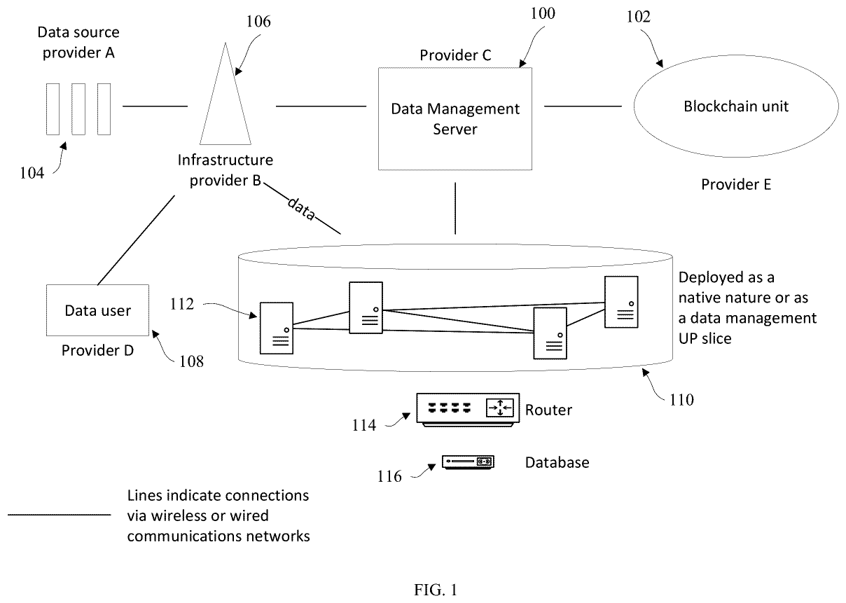

FIG. 1 illustrates an architecture for implementing a data management solution, according to an embodiment. The architecture allows data owners or data stakeholders to issue requests for data management to a system that allows for a wide variety of data access policies and anonymization solutions to protect privacy. Data owner 104 may be an individual who owns data, or a party with privacy concerns for the data. Data user 108 may use data. Either data owner 104 or data user 108 may make a request for data management to infrastructure 106. Data management, as used herein may include data storage, data retrieval, data sharing, data processing, or other data operations as found in computer networks. Data management server 100 provides data management services and implements service access controls that may be in the control plane of the network. Data management server 100 may be implemented using one or more computer servers that may be real or virtual, centralized or distributed, or any combination of server technology as is known in the art. After successfully being verified by an access control, which may be based on blockchain technology unit 102, a data packet may be delivered to a 116 database, or to data user 108, through a router 114 deployed by a network operator or controlled by the data management server 100. Database 116 may be deployed by infrastructure 106, or by data management server 100, or by a third party. Data owner 104 may provide data privacy and anonymization requirements to be included in access control policies to meet their requirements. In embodiments, data privacy requirements may be used to ensure compliance with government regulations such as the General Data Protection Regulation (GDPR) of the European Union. Access control policies may contain sensitive information about a user and if these access control policies are provided to a third party for audit or access control processes, private information may be leaked. Embodiments provide systems and methods that preserve the privacy of data owners when using data management services through the use of anonymizing solutions. Embodiments provide a data management server 100 that includes data management controller 204, an access policy entry point 212, an access policy management unit 210, and an access policy decision unit 208. The access policy management unit selects an anonymization solution for an access control policy and configures the corresponding parameters to be used for access control policy decisions or functions such as access control policy implementation details or an audit function. Lines in FIG. 1 indicate connections (e.g., data connections) provided, for example, via wired or wireless communication network links.

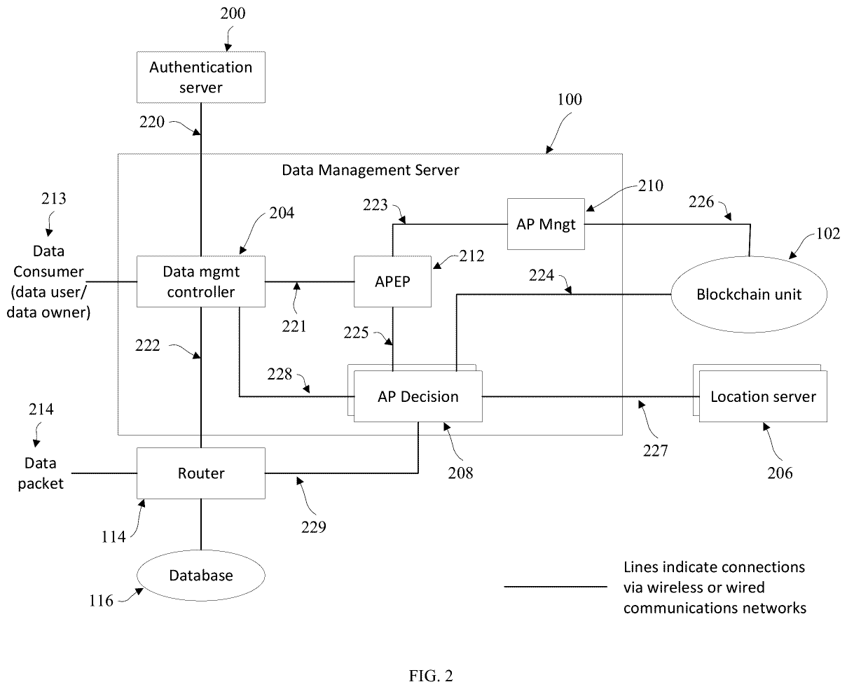

FIG. 2 illustrates an architecture for implementing access controls and protecting privacy in a network, according to an embodiment. Components of the architecture include a data management server 100, a router 114, a database 116, an authentication server 200, a blockchain technology unit 102 provided by a third party, and a location server 206. When a data consumer 212 (e.g., data owner 104 or data user 108) makes a request for data management services to a data management controller 204 may first request authentication of the data user or data owner 212 to the authentication server 200 through an interface 220, then the data management controller 204 makes a request for access control to an access policy entry point data management server (APEP) 212 through an interface 221. Lines in FIG. 2 indicate connections (e.g., data connections) provided, for example, via wired or wireless communication network links.

The data management server 100 consists of several modules including a data management controller 204, an access policy entry point (APEP) 212, an access policy (AP) decision unit 208, and an access policy (AP) management unit 210. The data management server 100 has several responsibilities. In response to receiving a request from the data management controller 204, the APEP 212 may request for access control policy management to the AP management unit 210, the AP decision unit 208, or both the AP management unit 210 and the AP decision unit 208. The AP decision unit 208 may query a location server 206 through interface 227 to obtain a location related to a data access control policy or to an access request to ensure that the data access control policy meets privacy regulations associated with a location, such as the GDPR in Europe. AP decisions unit 208 may also make a decision about data access after implementing access control through interface 224 and generates data access detection rules which may be sent to a router 114 through interface 229. The AP management unit 210 controls access policies (e.g., policy generation and policy modification), dynamically selects an anonymization solution for access policies, and sends information about the anonymization solution or parameters of the anonymization solution to a blockchain technology unit 102 through interface 226. Interfaces 223 and 225 may be used for internal communications with the data management server 100. Interface 223 is connected between the APEP 212 and the AP management unit 210 and may be used to deliver requests for policy operations or responses corresponding to the requests. Interface 225 is connected between the APEP 212 and the AP decision unit 208 and is used to send requests for data access control implementation or responses corresponding to the requests.

Once a successful access control policy has been determined, the data management controller 204 may set up and configure routing paths between selected routers 114 and databases 116 through interface 222 that may be used for the transmission of data packets.

Embodiments allow the data management server 100 to perform data classification, dynamic selection and configure of anonymization solutions, and the implementation of privacy access controls. Embodiments preserve the privacy of access policies and enable systems that meet privacy regulations such as the GDPR. Furthermore, the dynamic selection and configuration of anonymization solutions allow for the optimization of network resources while providing improved security and privacy protection.

In embodiments, the data management controller 204, the APEP 212, the AP management unit 210, and the AP decision unit may be deployed by the same or different data management providers. Data access policies with location dependent restrictions may be pre-configured or dynamically provided to the AP management unit 210.

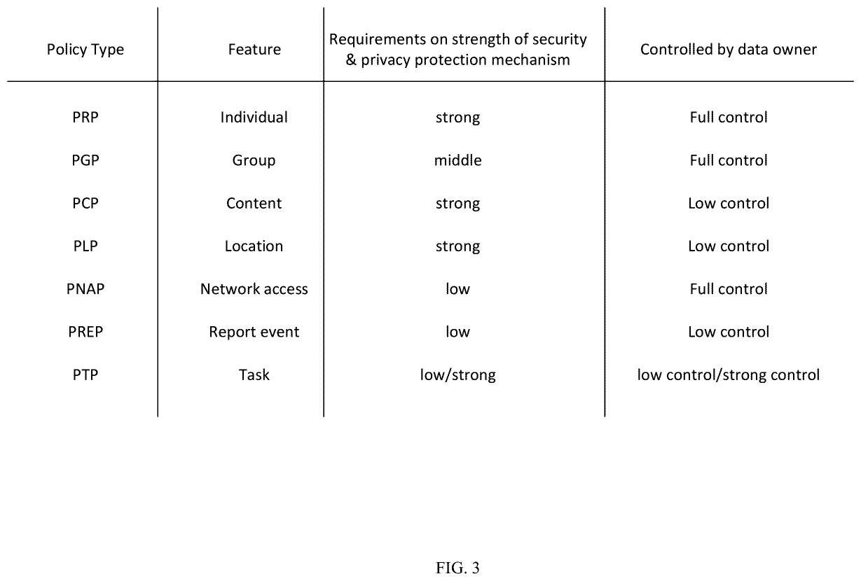

FIG. 3 illustrates a table of access control policy types and their characteristics, according to an embodiment. A data owner may provide information when making a request for data management services that allows the data owner a measure of control over how the data is handled, shared, or stored. This information may include data owner information, data information, data operation permissions, and an indication whether data owner wants to know of the data's usage, etc. Data owner information may include a data owner ID. Data information such as an abstract of the data, a data creation time, or a data modification time. Data operation permission may include access permissions such as read, write, modify, etc. Data usage information may be used to indicate who will use the data, what the data will be used for and for what purpose to meet privacy regulations (e.g., GDPR), where the data will be secure stored in or accessed from, a time window when data may be stored or accessed.

In embodiments, the APEP 212 may be used to classify data based on the data information and send the results of the data classification to the AP management unit 210. The AP management unit 210 may then select an anonymization solution and generate an access control policy based on factors such as the indication of what data owner wants to know concerning the data usage, regional restrictions which are published by regulations or laws, etc.

The AP management unit 210 may support different types of access policies based on the value of the indication of data usage. As examples, FIG. 3 includes that seven types of access policies broadly organized by their key features. Each type of policy includes at least a policy ID, policy feature, and data operation permissions. These key policy features include an individual role, a data group, data contents, location associated with the data, a type of network access used, reporting an event such as a notification or trigger, and a session or service task. Individual role policies are referred to as Permission-Role-Policy (PRP) and are based on an individual role. PRP policies specify data operation permissions (e.g., read, write, modify) during a time window. Since PRP policies are based on an individual role, a data owner may require full control of its own data while requiring from a strict security/privacy protection mechanism such as encryption to protect the security and privacy of their data. Group role policies are referred to as Permission-Group-Policy (PGP) and are based on a group which the data belongs to. The group may be a set of data with similar or same features or attributes. The PGP policy specifies data operation permissions (e.g., read, write, modify) during a time window. In the case of PGP policies, the data owner may not have full control of its own data and may require a middle or moderate strength security or privacy protection mechanism such as K-anonymity, to protect the security or privacy of the data. Policies based on a session or service task are referred to as Permission-Task-Policy (PTP) and provide data operation permissions (e.g., read, write, modify) during a time window. With PTP policies a data owner may have full control of its own data but require a strong security or privacy protection mechanism if the service is requested by a data owner. The data owner may have a low level of control over their own data but require a low level security or privacy protection mechanism or no security or privacy protection if the service is requested by a third party such as an external organization or an external platform. Network access policies are referred to as Permission-Network Access-Policy (PNAP) and are based on the type of network access used, such as access through a 3GPP compliant network or access through a non-3GPP compliant network. PNAP policies provide data operation permissions (e.g., read, write, modify) during a time window. Using PNAP policies, a data owner may have full control of its own data but require a low strength security or privacy protection mechanism. PNAP policies are based on reporting or reported events such as a notification of, and reaction to application events that may trigger new behavior in the network, and provide data operation permission (e.g., read, write, modify) during a time window. Using PNAP policies, a data owner may require a low level of control over its own data and require a low level security or privacy protection mechanism. Data content based policies are referred to as Permission-Content-Policy (PCP) and are based on data content. PCP polices provide data operation permission (e.g., read, write, modify) during a time window. With the use of PCP policies, a data owner may have a low control of its own data but require a strong level of security or privacy protection mechanism. Location based policies are referred to as Permission-Location-Policy (PLP) and are based on data locations, data owner location, data customer location, or some other location parameter that may entail location based data management. PLP policies may provide data operation permissions (e.g., read, write, modify) during a time window. With PLP policies, a data owner may have a low control of its own data but require a strong strength of security or privacy protection mechanism.

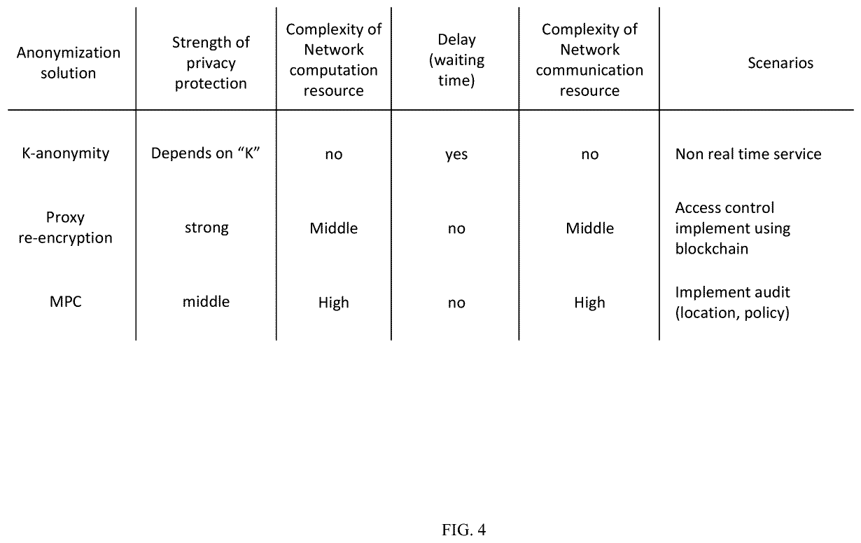

FIG. 4 illustrates a table of anonymization solutions and their characteristics, according to an embodiment. In some embodiments, a traditional K-anonymity technique may be used to protect a data owner's privacy. Using K-anonymity there must be at least k individuals (data owners) in the data set that share the same identifying attributes to increase the risk of re-identification of a data owner based on the attributes. For example, when constructing a PGP based policy, a set of subjects or resources may have the same operation permissions or meet the same security or privacy requirements.

In embodiments, proxy re-encryption techniques may be used to protect a data owner's privacy. For example, an AP management unit 210 may select a proxy re-encryption solution to protect policy privacy. The AP management unit 210 may encrypt sensitive information, such as the contents of the data description, using its own public key, construct a re-key which includes the private key of the AP management unit 210 and the public key of the AP decision unit 206 using a function such as a hash function. The AP management unit 210 sends the encrypted information and the re-key together with an access control policy to blockchain technology unit 102 through interface 226. The blockchain technology unit 102 re-encrypts the sensitive information using the re-key. When AP decision unit 208 needs access to the control policy to make a decision about allowing access, the AP decision unit 208 decrypts the encrypted sensitive information and then implements the access control policy.

In embodiments, a Multiple Player Computation (MPC) technique, where multiple parties jointly compute a function over their inputs while keeping those inputs private, may be used to protect a data owner's privacy. AP management unit 210 may select an MPC technique to protect policy privacy. The AP management unit 210 constructs a polynomial function (e.g., F_{A}(x)=a₀+a₁x), where parameter a₀ indicates sensitive information (e.g., a data description), parameter a₁ is a random secret number. The AP management unit 210 generates and splits a key into several segments (e.g., the size of segments may be 2). The AP management unit 210 keeps one segment and sends other segments to a location server 206 over interfaces 223, 225, or 227. The location server 206 constructs a polynomial function (e.g., F_{B}(x)=b₀+b₁x), where parameter b₀ indicates sensitive information (e.g., a data description) and parameter b₁ is a random secret number. The location server 206 generates and splits a key into several segments (e.g., the size of segments may be 2). The location server keeps one segment and sends other segments to the AP management unit 210. Later, both of the AP management unit 210 and the location server 206 may sum their received segments with their own kept segments, and send the summary results to a third party (e.g., an auditor function). The third party auditor calculates the result which enables successful access controls based on the received summaries.

As illustrated in FIG. 4, different anonymization solutions offer different levels of performance with regards to factors such as delay, latency, computation overhead, communication overhead, security protection level, and complexity. For example, the strength of privacy protection in the K-anonymity solution depends on the value of K. The K-anonymity solution required a low complexity of network computation resources or network communication resources, but it has a delay which is caused by waiting for at least K different entities that have the same or similar attributes. Thus, this scenario could be used for non-real time service. The proxy re-encryption solution could provide a high level of privacy protection due to encryption. The strong strength of privacy protection may indicate that this solution could guarantee security or privacy protection. The proxy re-encryption solution needs network computation resources and network communication resources, but it has little delay. Thus, this scenario could be used in an access control implementation using a blockchain. An MPC solution could provide a middle strength of privacy protection since polynomial functions may be broken, compared to the proxy re-encryption solution. The proxy re-encryption solution needs a large amount of network computation resources and network communication resources compared to the proxy re-encryption solution. Thus, this scenario is suited for a data operation audit application.

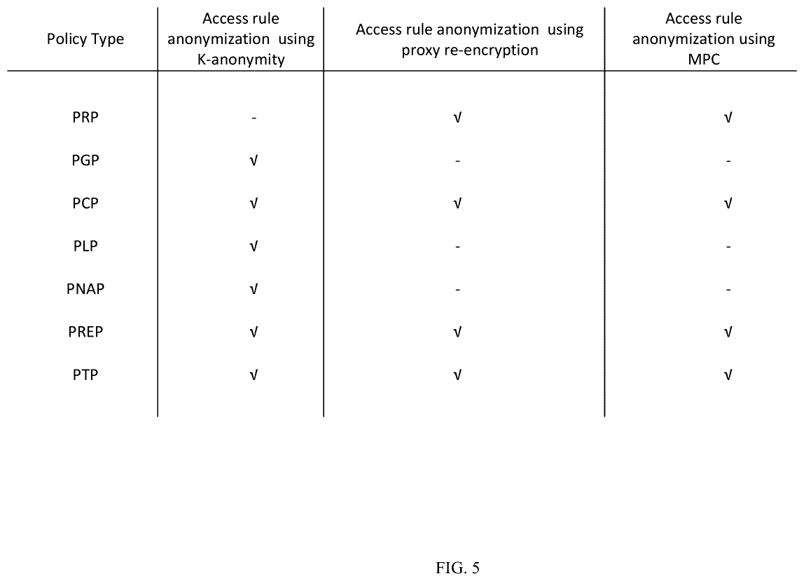

FIG. 5 illustrates a table comparing access control policies and anonymization solutions, according to an embodiment. Since different anonymization policies have different features and requirements for security and privacy, they require different anonymization solutions. In embodiments, a policy may belong to one or more types. For example, a policy may be only a PFP type, or a policy may simultaneously be a PGP, PCP, and PTP type. The selection of a suitable anonymization solution for each access control policy may be determined based on factors such as security requirements, privacy requirements, indication whether data owner wants to know of how data will be used, communication or computation complexity, delay, service, or other factors. A static-configuration selection criteria associating policies and the corresponding anonymization solutions may be insufficiently flexible and more complex algorithms may be required to select a better solution.

In embodiments, anonymization solutions offer different levels of performance with regards to delay, computation overhead, communication overhead, security protection level, complexity, and other parameters. Access rule anonymization using MPC may be used in a scenario where each of AP management unit 210 and the location server 206 is assumed to be sufficiently trusted. Security protection levels in an access rule anonymizing using a K-anonymity solution is dependent on the value of k. Access rule anonymizing using a proxy re-encryption solution may provide a high security protection level. FIG. 5 provides an example of a table that may be used to select an access rule anonymization solution for different access control policies. A PRP policy type may select a proxy re-encryption solution or an MPC solution. A PGP, PNAP, or PLP policy type may select a K-anonymity solution. A PCP, PTP, PREP policy type may can select a K-anonymity solution, a proxy re-encryption solution, or an MPC solution.

In embodiments, the AP management unit 210 may implement optimization algorithms to select a best anonymization solution for an access control policy. Different types of access control policies may be associated with different types of anonymization solutions. A dynamic selection of anonymization solutions for different access policies and configurations is provided, matching performance levels of solutions to policies. Embodiments provide flexible dynamic configuration and enable policy privacy protection and network resource optimizations to meet the needs of data owners, data users, and service providers.

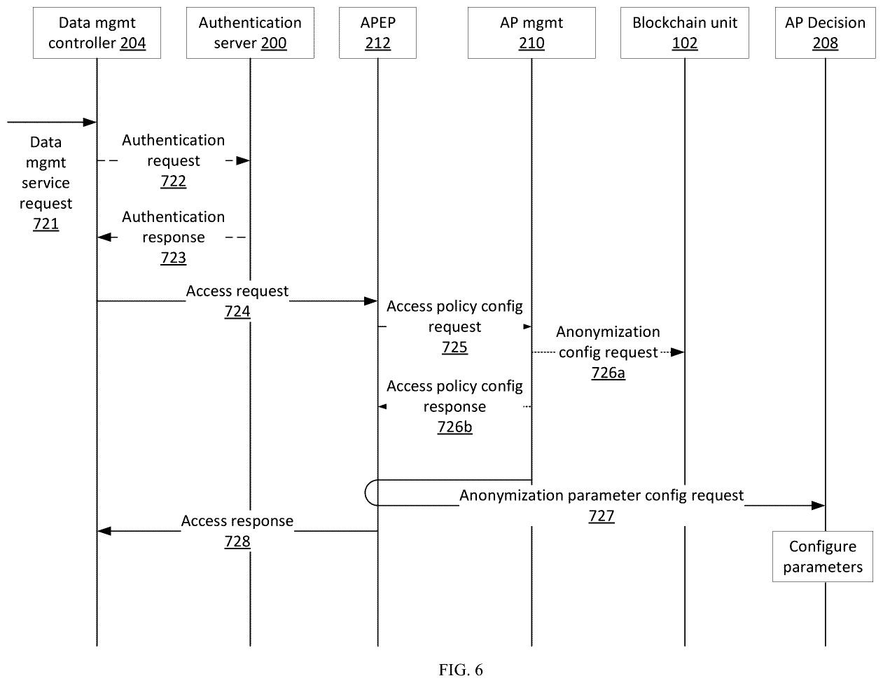

FIG. 6 illustrates a signal flow diagram for the dynamic configuration of anonymization solutions and access policies, according to an embodiment. If a data owner or a data stakeholder issues a request for a data management service to manage its own data, the data owner or data stakeholder may also provide a set of requirements for an access control policy for that data. These requirements may be stored and communicated in the data description. A data management controller 204 may issue requests to authenticate data management requests. Once a request has been successfully authenticated, an access control policy may be generated based on the data owner or the data stakeholder's requirements. The access control policy will provide criteria for the generation of data access detection rules which is used as a “gate control” before data packets are permitted to enter into or leave a storage system.

In communications networks, multiple service providers may join in implementing data operations and data accesses may be implemented using a chain of service providers in an ecosystem where the multiple service providers may not have a high level of trust between them. In embodiments, data access operations may be audited by a third party to monitor the actions of the data management provider or providers. In these situations, sensitive information may be contained in the access control policies and will be public to members of an access control chain if using access control implement based on blockchain, or auditors, and may lead to a leak of a data owner's private information. In embodiments, the AP management unit 210 may implement methods to protect private information contained in access control policies. Note that, if functions such as the data management controller 204, the APEP 212, the AP management unit 210, or the AP decision unit 208 are deployed by different data management service providers, sensitive information related to access control policies provided by data owner, may be encrypted. In embodiments, only the AP management unit 210 may decrypt and obtain sensitive information. In embodiments, anonymization solutions may be used to protect the privacy of data owners.

Embodiments include methods for the dynamic selection and configuration of anonymization solutions for access policies. These methods may be initiated by a data owner requesting a data management service by sending a data management service request. Data owners may modify operation permissions applicable to their personal data. Similarly, data users such as data processors, may be granted permission from a data owner to modify a data owner's permissions. Therefore, these methods may be trigged by an entity (e.g., data owner, or data user) who sends a policy modification request. In some embodiments, network computation resource or network communication resource or scenarios may trigger this procedure since anonymization solutions depend on the above factors through a policy modification request.

The method of FIG. 6 commences when an entity sends a data management service request 721 to a data management controller 204. The data management service request 721 includes an indication whether data owner wants to know of usage (e.g., who will use the data to meet privacy regulations, what data will be used, where will the data be secure stored, which is the purpose for using the data to meet privacy regulations, how will the data be secure stored, a time window for storage or access to data to meet privacy regulations). If the indication shows that data owner wants to know of usage, it will trigger AP management unit 210 to dynamic selection and configuration of anonymization solutions for access policies. This request may also include a data owner's information (e.g., data owner ID), a data information (e.g., data abstract, data creation time), a data operation's permission (e.g., read, write, modify). AP management unit 210 generates or modifies access policies based on the data owner's information, the data information, the data operation's permission. When receiving a policy modification request, the request may include an identifier, such as a policy ID, together with data operation permissions, or a new indication.

The data management controller 204 may send an authentication request 722 to an authentication server 200. The authentication request 722 includes the data owner ID to be authenticated. In response to the authentication request 722, the authentication server 200 sends an authentication response 723 with an indication whether the data owner passes the authentication or not. If the indication shows that the data owner has been successfully authenticated, the data management controller 204 may issue an access request 724 to an APEP 212. The access request 724 may include the information in the data management service request. After receiving the access request 724, the APEP 212 may classify data based on the data information, and send another request for data management. In this and potentially other embodiments, the request for data management can be an access control policy configuration request 725, to an AP management unit 210. The access control policy configuration request 725 may include the value of the data classification, and the information in the data management service request.

After receiving the access control policy configuration request 725, the AP management unit 210 may have two options: (1) if the indicator shows that data owner does not need to know of the data's usage, the AP management unit 210 may generate an access control policy based on the data information and the data operation permission, and send a response, such as the access control policy configuration response 726b, to the APEP 212. The response may include a policy ID. (2) If the indicator shows that the data owner wants to know the usage of the data, the AP management unit 210 may generate or modify an access control policy to meet relevant security or privacy regulations. AP management unit 210 selects a type of access control policy from the types of the access control policy are listed in FIG. 3. This selection is based on the data information and the data operation permission. Then, the AP management unit 210 selects a suitable anonymization solution and generates any corresponding parameters required by the selected anonymization solution. The selected anonymization solution may be implemented by an optimization algorithm based on factors illustrated in FIG. 4. The AP management unit 210 may then send a message, such as an anonymization configuration request 726a, to a blockchain technology unit 102 and then send an access control policy configuration response 726b (or other similar response) to the APEP 212. The anonymization configuration request 726a may include a policy ID, an anonymization index which indicates the selected anonymization solution. If the selected anonymization solutions is K-anonymity solution, the request may also include a value of k. If the selected anonymization solution is a MPC solution, the request may also include parameters for the polynomial functions. If the selected anonymization solution is a proxy re-encryption solution, the request may also include a re-encryption key generation function and public keys.

The access control policy configuration response 726b may include the information in the anonymization configuration request the policy ID. The AP management unit 210 may send a message, such as an anonymization parameter configuration request 727, via the APEP 212, to the AP decision unit 208. In embodiments, the anonymization parameter configuration request 727 may be viewed as a “first message” (as that term is used herein). In embodiments, the anonymization configuration request 726a may be viewed as a “second message” as that term is used herein. This request 727 may include the policy ID, the anonymization index, the parameters. After receiving it, AP decision unit 208 keeps the parameters received in the anonymization parameter configuration request 727.

The APEP 212 sends an access response 728 to the data management controller 204. This response 728 may include the policy ID. In some embodiments, the response may be sent to the data owner. It is noted that the AP management unit may communicate the policy ID via the APEP.

Embodiments illustrated in FIG. 6 provide methods for the dynamic configuration of anonymization solutions for an access control policy. An AP management unit 210 dynamically selects a suitable anonymization solution when the indication shows that data owner wants to know usage of the data to protect privacy or security, and generates an access control policy using the selected anonymization solution. The AP management unit 210 also configures and sends parameters of the selected anonymization solution. Methods provide access control policies for privacy protection and network resource optimization. Policy selection, generation, and configuration is based on an indication of data usage which is defined by the data owner, providing the data owner control over its data.

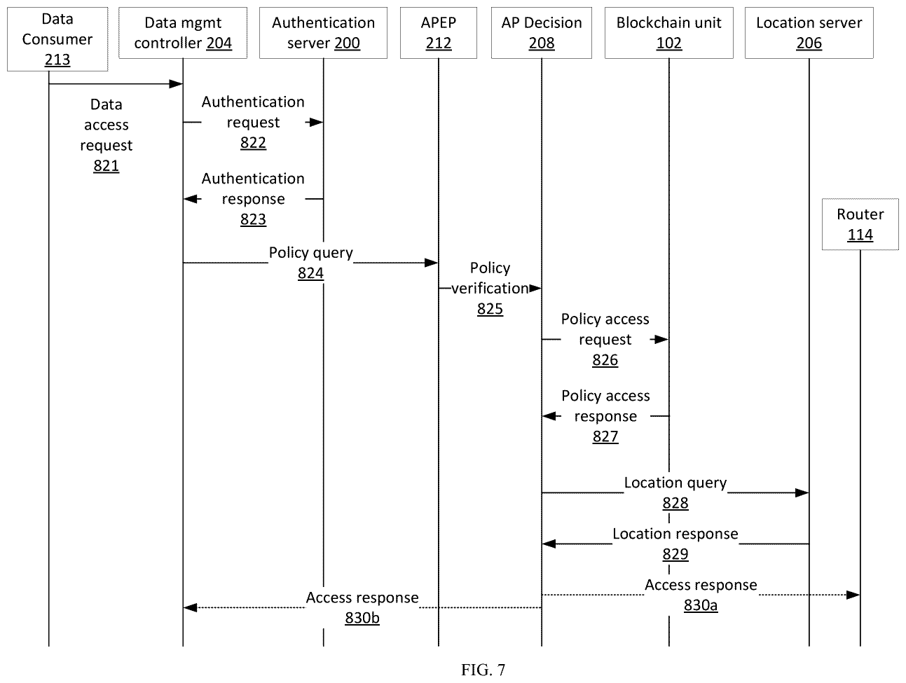

FIG. 7 illustrates a signal flow diagram for the policy access control procedure, according to an embodiment. A data user or data customer 108 sends a data access request 821 to a data management controller 204. The data access request 821 may include one or more parameters such as an ID of the data user and access data information indicating what data will be accessed or whose data will be accessed. Access data information may also indicate policy information such as a policy ID.

After receiving the data access request 821, the data management controller 204 sends an authentication request 822 to an authentication server 200. The authentication request 822 may include the ID of the data user. The authentication server 200 may verify the data user, and return an authentication response 823 to the data management controller 204 which indicates whether the data user is passed authentication or not. If the authentication response 823 indicates a successful authentication, the date management controller 204 may send a policy query 824 to an APEP 212. The policy query 824 may include the ID of the data user 108 and the access data information. The APEP 212 may send a policy verification request 825 to an AP decision unit 208. The policy verification request 825 may include the ID of the data user, and access data information. The policy verification request 825 may also include the policy information (e.g., the policy ID).

The AP decision unit 208 may send a policy access request 826 to blockchain technology unit 102. The policy access request 826 may include the access data information if the policy verification request does not have the policy information. The policy access request 826 may also include the policy information (e.g., the policy ID).

The blockchain technology unit 102 may determine a policy based on the access data information, and obtain a policy information (e.g., policy ID), and may send a policy access response 827 to the AP decision unit 208. This response may include the policy ID, the policy corresponding to the policy ID, to the AP decision unit 208. After the AP decision unit 208 receives the policy access response 827, the AP decision unit 208 may search for the anonymization solution ID based on the policy ID, and configure parameters of the corresponding anonymization solution, and then may obtain, decrypt, or compute the access policy. Then, AP decision unit 208 checks whether the policy has or requires location verification to meet to privacy regulations.

If it requires location verification, the AP decision unit 208 sends a location query request 828 to a location server 206. The location query request 828 may include the ID of the data user. The location server 206 then returns a location of the data user to the AP decision unit 208 in a location response 829. The AP decision 208 determines that the data user has permission to access the requested data according to the policy, and then generates a data access detection rule if the data user has permission to access the requested data. Then, the AP decision unit 208 sends an access response message which includes the result which indicates permission to access the requested data for the data user together with the data access detection rules. This message may be sent to the data management controller 204 in access response 830b, or to a router 114 in access response 830a. The data management controller 204 may set up a routing path between router 114 to a database 116 for data transfer to the data user.

In embodiments, access controls are implemented to provide policy protection through a selected anonymization solution. Methods meet privacy regulation (e.g., GDPR) requirements through location verification done by an AP decision unit 208.

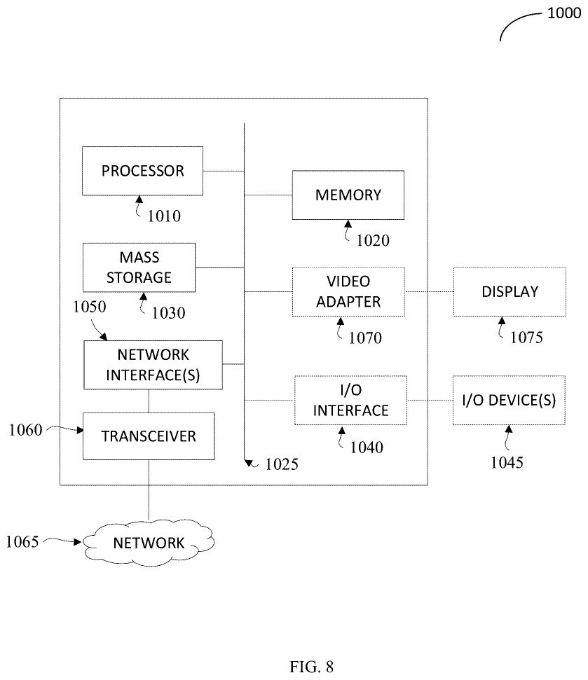

FIG. 8 is a schematic diagram of an electronic device 1000 that may perform any or all of operations of the above methods and features explicitly or implicitly described herein, according to different embodiments of the present invention. For example, a computer equipped with network function may be configured as electronic device 1000.

As shown, the device includes a processor 1010, such as a central processing unit (CPU) or specialized processors such as a graphics processing unit (GPU) or other such processor unit, memory 1020, non-transitory mass storage 1030, I/O interface 1040, network interface 1050, video adaptor 1070, and a transceiver 1060, all of which are communicatively coupled via bi-directional bus 1025. Video adapter 1070 may be connected to one or more of display 1075 and I/O interface 1040 may be connected to one or more of I/O device 1045 which may be used to implement a user interface. According to certain embodiments, any or all of the depicted elements may be utilized, or only a subset of the elements. Further, the device 1000 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 1020 may include any type of non-transitory memory such as static random access memory (SRAM), dynamic random access memory (DRAM), synchronous DRAM (SDRAM), read-only memory (ROM), any combination of such, or the like. The mass storage element 1030 may include any type of non-transitory storage device, such as a solid state drive, hard disk drive, a magnetic disk drive, an optical disk drive, USB drive, or any computer program product configured to store data and machine executable program code. According to certain embodiments, the memory 1020 or mass storage 1030 may have recorded thereon statements and instructions executable by the processor 1010 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations, or equivalents that fall within the scope of the present invention.

1. A method comprising:
receiving, by an access policy management unit from an access policy entry point (APEP), a request for data management, wherein the request for data management includes a data description of data;
in response to the request for data management, sending, by the access policy management unit to the APEP, a response to acknowledge a generation of an access control policy for management of the data, wherein the generation of the access control policy is based on the data description of the data;
wherein the data description of the data includes an indication indicating whether an owner of the data expects to know usage of the data, the generation of the access control policy includes:
when the indication indicates that the owner of the data expects to know the usage of the data, a generation of the access control policy based on one or more of a security requirement related to the data, a privacy requirement related to the data, data information and a data operation permission related to the data; and
when the indication indicates the owner of the data does not expect to know the usage of the data, a generation of the access control policy based on data information and a data operation permission related to the data.

2. The method according to claim 1, wherein the method further comprises:
sending, by the access policy management unit to an AP decision unit, a first message including:
a policy ID of the access control policy,
an index indicating an anonymization solution, and
one or more parameters related to the anonymization solution; and
sending, by the access policy management unit to a blockchain unit, a second message including:
a processed access control policy wherein the processed access control policy is a result of processing the access control policy according to the anonymization solution and the one or more parameters related to the anonymization solution,
the policy ID of the access control policy,
the index indicating the anonymization solution, and
the one or more parameters related to the anonymization solution.

3. The method according to claim 2, wherein, prior to sending the first message and the second message, the method further comprises:
determining, by the access policy management unit, an anonymization solution for a privacy protection of the access control policy according to one or more of: a strength of the privacy protection, complexity of a resource for a network computation, tolerance of a time delay due to the generation of the access control policy, or complexity of a resource for a network communication.

4. The method according to claim 1, wherein, prior to sending the response, the method further comprises:
selecting from a set of types of the access control policy, by the access policy management unit, a type of the access control policy according to the data information and the data operation permission.

5. The method according to claim 2, wherein the method further comprises:
receiving, by the blockchain unit from the access policy management unit, the second message; and
storing, by the blockchain unit, information received from the access policy management unit.

6. The method according to claim 2, wherein the method further comprises:
receiving, by the AP decision unit from the access policy management unit, the policy ID of the access control policy, the index indicating the anonymization solution and the one or more parameters related to the anonymization solution;
receiving, by the AP decision unit from a data management controller, a policy query for accessing the data;
obtaining, by the AP decision unit from the blockchain unit, the processed access control policy for the data; and
sending, by the AP decision unit to the data management controller, a response to the policy query indicating whether the data is accessible.

7. The method according to claim 6, wherein the method further comprises:
determining, by the AP decision unit, whether the data is accessible based on the data policy.

8. The method according to claim 6, wherein the obtaining the processed access control policy for the data comprises:
sending, by the AP decision unit to the blockchain unit, the policy access request for an access control policy for the data, wherein the policy access request from the AP decision unit comprises one or more of data information indicating data to be accessed, and policy information including a policy ID; and
receiving, by the AP decision unit from the blockchain unit, the policy access response including the processed access control policy and a policy ID of the access control policy.

9. The method according to claim 8, wherein the method further comprises:
de-processing, by the AP decision unit, the processed access control policy received from the blockchain based on the anonymization solution and the one or more parameters related to the anonymization solution.

10. The method according to claim 9, wherein after the de-processing the processed access control policy, the method further comprises:
sending, by the AP decision unit to a location server, a location query for a location of a data consumer of the data; and
receiving, by the AP decision unit from the location server, the location of the data consumer of the data;
wherein the AP decision unit determines whether the data is accessible based on the data policy and the location of the data consumer of the data.

11. An apparatus comprising a processor coupled with a memory storing instructions, which when executed by the apparatus, cause the apparatus to perform the step of:
receiving from an access policy entry point (APEP), a request for data management, wherein the request for data management includes a data description of data;
in response to the request for data management, sending to the APEP, a response to acknowledge a generation of an access control policy for management of the data, wherein the generation of the access control policy is based on the data description of the data;
wherein the data description of the data includes an indication indicating whether an owner of the data expects to know usage of the data, the generation of the access control policy includes:
when the indication indicates that the owner of the data expects to know the usage of the data, a generation of the access control policy based on one or more of a security requirement related to the data, a privacy requirement related to the data, data information and a data operation permission related to the data; and
when the indication indicates the owner of the data does not expect to know the usage of the data, a generation of the access control policy based on data information and a data operation permission related to the data.

12. A system comprising an access policy management unit and an access policy entry point (APEP), wherein:
access policy management unit is configured to receive from the APEP a request for data management, wherein the request for data management includes a data description of data; and
in response to the request for data management, the access policy management unit sends to the APEP, a response to acknowledge a generation of an access control policy for management of the data, wherein the generation of the access control policy is based on the data description of the data; and
wherein the APEP is configured to send the request and receive the response;
wherein the data description of the data includes an indication indicating whether an owner of the data expects to know usage of the data, the generation of the access control policy includes:
when the indication indicates that the owner of the data expects to know the usage of the data, a generation of the access control policy based on one or more of a security requirement related to the data, a privacy requirement related to the data, data information and a data operation permission related to the data; and
when the indication indicates the owner of the data does not expect to know the usage of the data, a generation of the access control policy based on data information and a data operation permission related to the data.

13. The system according to claim 12, wherein the access policy management unit is further configured to:
send, to an AP decision unit, a first message including:
a policy ID of the access control policy,
an index indicating the anonymization solution, and
one or more parameters related to the anonymization solution; and
send, to a blockchain unit, a second message including:
a processed access control policy wherein the processed access control policy is a result of processing the access control policy according to the anonymization solution and the one or more parameters related to the anonymization solution,
the policy ID of the access control policy,
the index indicating the anonymization solution, and
one or more parameters related to the anonymization solution.

14. The system according to claim 13, wherein the access policy management unit is further configured to:
prior to sending the first message and the second message,
determine an anonymization solution for a privacy protection of the access control policy according to one or more of: a strength of the privacy protection, complexity of a resource for a network computation, tolerance of a time delay due to the generation of the access control policy, complexity of a resource for a network communication.

15. The system according to claim 12, wherein the access policy management unit is further configured to:
prior to sending the response,
select from a set of types of the access control policy, by the access policy management unit, a type of the access control policy according to the data information and the data operation permission.

16. The system according to claim 13, wherein the system further comprises the blockchain unit configured to:
receive from the access policy management unit, the second message; and store information received from the access policy management unit.

17. The system according to claim 13, wherein the system further comprises an AP decision unit configured to:
receive, from the access policy management unit, the policy ID of the access control policy, the index indicating the anonymization solution and the one or more parameters related to the anonymization solution;
receive, from a data management controller, a request for accessing the data;
obtain, from the blockchain unit, the processed access control policy for the data; and
send, to the data management controller, a response indicating whether the data is accessible.

18. The system according to claim 17, wherein the AP decision unit is further configured to:
determine whether the data is accessible based on the data policy.

19. The system according to claim 17, wherein the AP decision unit is configured to obtain the processed access control policy for the data by:
send a policy access request to the blockchain unit for an access control policy for the data, wherein the policy access request from the AP decision unit comprises one or more: data information indicating data to be accessed, and policy information including a policy ID; and
receive, from the blockchain unit, a policy access response including the processed access control policy and a policy ID of the access control policy.

20. The system according to claim 19, wherein the AP decision unit is further configured to:
de-process the processed access control policy received from the blockchain based on the anonymization solution and the one or more parameters related to the anonymization solution.
